(19) United States
(12) Patent Application Publication
(10) Pub. No.: US 2011/0139953 A1
(43) Pub. Date: Jun. 16, 2011

(54) Hanger System and Method

(76) Inventors: Brent Wittke, Phoenix, AZ (US); David Adamson, Goodyear, AZ (US)

(21) Appl. No.: 12/966,832

(22) Filed: Dec. 13, 2010

Related U.S. Application Data
(60) Provisional application No. 61/286,260, filed on Dec. 14, 2009.

(51) Int. Cl. F16M 13/02; F16B 45/00; B23P 11/00

(52) U.S. Cl. 248/323; 29/525.01

(57) ABSTRACT

Embodiments of the invention provide a hanger system and method. The hanger system can include a first member and a second member. The first member and the second member can be capable of being moved with respect to each other in order to adjust a first length of the hanger system. In some embodiments, the first member can include at least one aperture and a fastener can be substantially positioned through the second member with the fastener capable of at least partially fixing a position of the first member with respect to the second member. A slot can be included through a portion of the second member and the slot can be capable of enabling a support structure to be coupled to the at least one aperture.

### RELATED APPLICATIONS

This application claims priority under 35 U.S.C. §119 to U.S. Provisional Patent Application No. 61/286,260 filed on Dec. 14, 2009, the entire contents of which is incorporated herein by reference.

### BACKGROUND

For some industrial, retail, warehouse, and other applications, it can be necessary to hang different support structures from various building components. For example, in some applications, it can be necessary to provide an apparatus or system to which support structures can be coupled so that the support structures can be suspended above a targeted area. These apparatuses or systems can be used to support numerous support structures including sprinkler systems, video surveillance systems, registration systems, and many others. Additionally, the apparatuses can be attached to a variety of building components so that the support structures can be hung in numerous different locations.

### SUMMARY

Embodiments of the invention provide a hanger system and method. The hanger system can include a first member and the first member can comprise a first main body, a first plate, a first hook, and a first protrusion. In some embodiments, the first main body can include at least one aperture, the first hook can be capable of moving with respect to the first plate, and the first hook and the first protrusion can be capable of at least partially engaging a building structure to at least partially support the hanger system. In some embodiments, the hanger system can comprise a second member and the second member can comprise a second main body, a second plate, a second hook, and a second protrusion. The second hook can be capable of moving with respect to the second plate, and the second hook and the second protrusion can be capable of at least partially engaging the building structure to at least partially support the hanger system. Also, the first member and the second member can be capable of moving with respect to each other in order to adjust a first length of the hanger system, and the second member can be capable of receiving a portion of the first member. Some embodiments provide a fastener substantially positioned through a portion of the second member, and the fastener can be capable of at least partially fixing a position of the first member with respect to the second member. Some embodiments provide an elongated aperture formed in the second main body and the elongated aperture can be capable of enabling a support structure to be coupled to the at least one aperture.

Some embodiments of the invention provide a hanger system comprising a first member with the first member comprising a first main body and a first plate. The first main body can include at least one aperture and a first width and the first plate can include a first protrusion and a first hook. In some embodiments, the first hook and the first protrusion can be capable of at least partially engaging a building structure to at least partially support the hanger system. Some embodiments provide a second member comprising a second main body and a second plate. The second main body can include a second width. The second plate can include a second protrusion and a second hook, and the second protrusion and the second hook can be capable of at least partially engaging the building structure to at least partially support the hanger system. The first member and the second member can be capable of being moved with respect to each other in order to adjust a first length of the hanger system, and the second member can be capable of receiving a portion of the first member. Some embodiments provide that the second width can be greater than the first width. Also, some embodiments provide that an elongated aperture can be formed in the second member and the elongated aperture can be capable of enabling a support structure to be coupled to the at least one aperture.

Some embodiments of the invention provide a method for securing a support structure to a building component, with the method comprising providing a hanger system. In some embodiments the hanger system can include a first member and a second member, and the second member can include a fastener. Further, some embodiments provide that the first member can comprise a first protrusion, at least one aperture, and a first hook. The second member can comprise a second protrusion, a second hook, and an elongated aperture formed in the second member. Some embodiments can include receiving a portion of the first member within the second member and actuating the fastener to at least partially fix a position of the first member with respect to the second member. Also some embodiments can include engaging the first and second protrusions and the first and second hooks with the building component, and coupling the support structure to the at least one aperture, and the support structure can extend at least partially through the elongated aperture.

### DESCRIPTION OF THE DRAWINGS

FIG. 1 is top view of a hanger system according to one embodiment of the invention.

FIG. 2 is a side view of the hanger system of FIG. 1.

FIG. 3 is a bottom view of the hanger system of FIG. 1.

FIG. 4 is a side view of building components including the hanger system according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

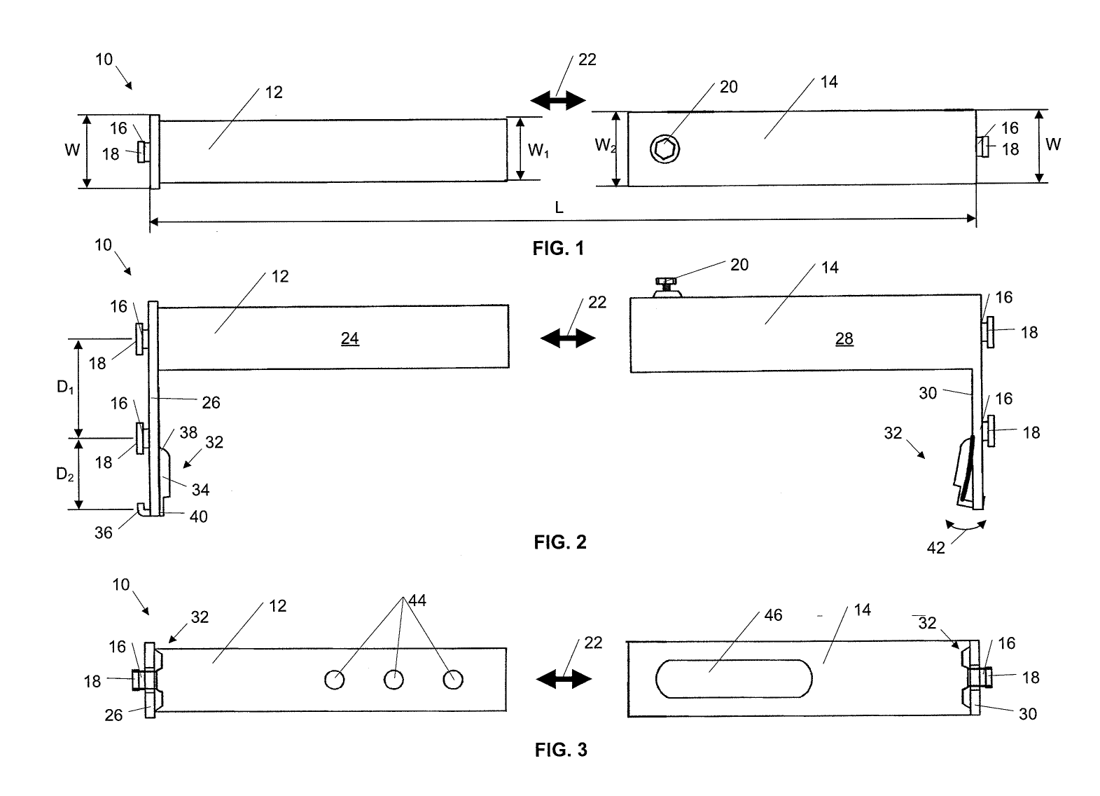

FIG. 1 illustrates a hanger system 10 according to one embodiment of the invention. The hanger system 10 can include a first member 12 and a second member 14. In some embodiments, at least one of the first member 12 and the second member 14 can include at least one projection 16, however, in other embodiments, both the first member 12 and the second member 14 can include projections 16. Further, in some embodiments, the first member 12 and the second member 14 can each include a plurality of projections 16. For example, in some embodiments, the first member 12 can include at least a first projection and the second member 14 can include at least a second projection. In some embodiments, the projections 16 can include a generally circular shape, although in other embodiments, the projections 16 can include a rectangular, square, polygonal, or any other suitable shape, including a combination of any of the previously mentioned shapes.

In some embodiments, each projection 16 can include a head 18, although some projections 16 can generally lack the head 18. In some embodiments, the head 18 can include a generally circular shape, although in other embodiments, the head 18 can include a rectangular, square, polygonal, or any other suitable shape, including a combination of any of the previously mentioned shapes. In some embodiments, the head 18 can be substantially positioned at a lateral edge of the projection 16 and the head 18 can include a generally greater width relative to the projection 16, although the respective widths of the head 18 and the projection 16 can vary. For example, in some embodiments in which the head 18 and the projection 16 comprise a generally circular shape, a circumference and a diameter of the head 18 can be generally greater than a circumference and a diameter of the projection 16. Additionally, referring to FIG. 1, in some embodiments, the projection 16 can be substantially centrally positioned with respect to a width W of the first member 12 and the second member 14. Also, in some embodiments, the hanger system 10 can be coated with powder coating, paint, or other desirable materials.

As indicated by arrow 22, in some embodiments, the first member 12 and the second member 14 can be moved with respect to each other. In some embodiments, a portion of the first member 12 can be inserted into, or can be received by a portion of the second member 14 and can slide with respect to the second member 14 because, in some embodiments, the second member 14 can comprise a greater width than the first member 12.

In some embodiments, the second member 14 can include a fastener 20. In some embodiments, the fastener 20 can be substantially positioned through, and extend at least partially into the second member 14. In some embodiments, a user can actuate the fastener 20, which can lead to the fastener 20 at least partially fixing a position of the first member 12 with respect to the second member 14. In some embodiments, the fastener 20 can fix a length L of the hanger system 10. In some embodiments, the fastener 20 can comprise a threaded fastener, however, in other embodiments, the fastener 20 can include any other suitable fastener which could be capable of at least partially fixing the position of the first member 12 with respect to the second member 14.

FIG. 2 illustrates a side view of the hanger system 10 according to one embodiment of the invention. In some embodiments, the first member 12 and the second member 14 can be substantially L-shaped, although the first member 12 and the second member 14 can comprise other shapes and need not both comprise the same shape.

In some embodiments of the invention, the first member 12 can include a first main body 24 and a first plate 26. In some embodiments, the second member 14 can include a second main body 28 and a second plate 30. In some embodiments, the first main body 24 can comprise a width W₁ that can be generally less than a width W₂ of the second main body 28, as shown in FIG. 1. In some embodiments, the second main body 28 can receive a portion of the first main body 24, although in other embodiments, the first main body 24 can receive the second main body 28. In some embodiments, the first main body 24 and the second main body 26 can complement each others' shape. In some embodiments, a cross section of the first main body 24 and/or the second main body 28 can include rectangular, circular, and any other suitable shapes. In some embodiments, the first member 12, the second member 14, the first main body 24, the first plate 26, the second main body 24, the second plate 30, and any other components of the hanger system 10 can be formed from metals, metal alloys, such as steel, polymers, metal-polymer composites, any other suitable materials, or any combination of any of the previously mentioned materials. For example, in some embodiments, the main bodies 24, 28 can be formed from substantially hollow tube steel. Further, in some embodiments, the main bodies 24, 28 can be coupled to the plates 26, 30 in any conventional coupling method including, but not limited to threaded fasteners, adhesives, welding, braising, any other type of fastener, any other suitable coupling techniques, or any combination of any of the previously mentioned techniques. Additionally, in some embodiments, the main bodies 24, 28 can be molded or cast with the plates 26, 30 so that each respective main body and plate comprises substantially one unit.

In some embodiments, the projection 16 can be positioned on at least one of the first plate 26 and the second plate 30, although in some embodiments, projections 16 can be positioned on either both, or neither of the first plate 26 and the second plate 30. Referring to FIG. 2, in some embodiments, the first member 12 and the second member 14 can each include projections 16 vertically spaced apart by a distance D₁. In some embodiments, the distance D₁ can be an integer multiple of a rack mounting unit (RMU) or any other standardized distance known for shelving units, racks, storage systems, and other building components.

In some embodiments, the hanger system 10 can include a hook 32. In some embodiments, both the first member 12 and the second member 14 can each include a hook 32, however, in some embodiments, either one of, or neither of the first member 12 or the second member 14 can include a hook 32. For example, in some embodiments, the first member 12 can include a first hook and the second member 14 can include a second hook. In some embodiments, the hook 32 can include a flat body 34 and an extension 36. The flat body 34 can include a first end 38 and a second end 40. In some embodiments, the first end 38 can be coupled to first plate 26 and/or the second plate 30. In some embodiments, the first end 38 can be coupled to the first plate 26 or the second plate 30 using threaded fasteners, adhesives, welding, braising, any other type of fastener, any other suitable coupling techniques, or any combination of any of the previously mentioned techniques. In some embodiments, the extension 36 can be coupled to the second end 40 by any of the previously mentioned coupling techniques.

Also, in some embodiments, the extension 36 can be generally dimensioned in relation to the projection 16 and the head 18 so that a lateral edge of the extension 36 extends away from the plates 26, 30 about the same distance that a lateral edge of the projection 16 and the head 18 extend away from the plates 26, 30. The hook 32 can be coupled to the first member 12 or the second member 14 in such a way that the extension 36 is a distance D₂ from the projection 16. In some embodiments, the distance D₂ can be an integer multiple of an RMU or any other standardized distance known for shelving units, racks, storage systems, or building components. In some embodiments, the distance D₁ and the distance D₂ can be substantially equal.

In some embodiments, the extension 36 can move relative to the first member 12, the first plate 26, the second member 14, or the second plate 30, as indicated by arrow 42. In some embodiments, the extension's 36 movement can comprise rotation, but in other embodiments, the movement can comprise any other type of movement. In some embodiments, the first end 38 can comprise a center of movement so that, generally, the extension 36 can move or pivot relative to the first end 38. In some embodiments, the flat body 34 can comprise a leaf spring or other biasing device, which can at least partially aid in movement of the extension 36.

FIG. 3 illustrates a bottom view of the hanger system 10 according to one embodiment of the invention. The first member 12 can include an aperture 44, although in some embodiments, the aperture 44 can comprise more than one aperture, such as, for example only, three apertures 44. Further, in some embodiments, the apertures 44 can comprise a threaded inner diameter. In some embodiments, for example, the apertures 44 can be drilled through at least one wall of the first member 12. Also, in some embodiments, the apertures 44 can further comprise threaded rod couplings (not shown), which can be coupled to the first member 12 near to the apertures 44 so that the apertures 44 can enable attachment of support structures or support devices, such as, for example only, a piping system of a sprinkler system. In some embodiments, the rod couplings can be coupled to the first member 12 using welding, threaded fasteners, adhesives, or any other suitable coupling methods.

In some embodiments, the support structures or the support devices can include threading which can be capable of engaging the threading on the apertures 44 so that the apertures can aid in coupling the hanger system 10 with the support structures or the support devices. Further, in some embodiments, the apertures 44 can be used to substantially centrally align the support structures or the support devices between the first plate 26 and the second plate 30. In some embodiments, the apertures 44 can enable a central alignment of the support structures or support devices so that the length L of the hanger system can comprise about 8 inches, about 10 inches, and about 12 inches.

In some embodiments, the hanger system 10 can include an elongated aperture 46 formed in the second member 14, although the elongated aperture 46 can be positioned in generally any location on or in the system 10. In some embodiments, the elongated aperture 46 can be positioned and dimensioned so that after the portion of the first member 12 is received by the second member 14, at least one of the apertures 44 can be used for the coupling of the support structures or the support devices to the hanger system 10, generally regardless of a length of the hanger system 10. In some embodiments, the elongated aperture 46 can comprise a generally rectangular shape, although in other embodiments, the elongated aperture 46 can comprise a square, polygonal, circular, or irregular shape. Further, in some embodiments, the elongated aperture 46 can comprise multiple elongated apertures 46.

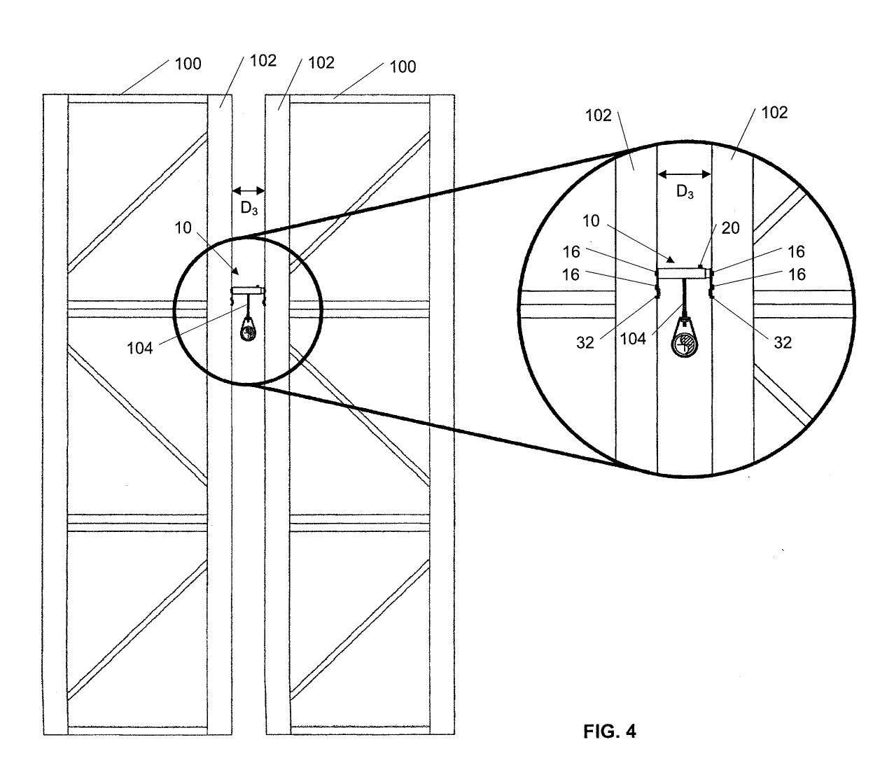

In some embodiments, the hanger system 10 can engage a building structure so that the hanger system can be at least partially supported by the building structure. In some embodiments, the building structure can comprise at least one shelving unit, joists, studs, rafters, support pillars, or any other similar structures used inside of, or for support of buildings. For example, FIG. 4 illustrates the hanger system 10 installed between shelving units 100 according to one embodiment of the invention. The two shelving units 100 can each include a rail 102. The rail 102 can include a plurality of installation apertures (not shown). In some embodiments, the installation apertures can be positioned on the rail 102 in a substantially regular pattern. In some embodiments, the installation apertures can be substantially equally spaced apart. Further, in some embodiments, the installation apertures can be an integer multiple of an RMU. In some embodiments, the first distance D₁ and the second distance D₂ can correlate to the spacing of the installation apertures of the rail 102.

In some embodiments, to engage the hanger system 10 with the shelving units 100, a portion of the first member 12 can be inserted into, and received by the second member 14. In some embodiments, at least a portion of the projections 16 and the heads 18 can be inserted into the installation apertures of the rails 102. The length L of the hanger system 10 can be adjusted according to a third distance D₃ between the shelving units, although in other embodiments, the length L can be adjusted to any desired length. In some embodiments, after inserting the portion of the projections 16 and the heads 18 into the installation apertures, a generally downward force can be applied to the hanger system 10 in order to engage the projections 16 and the heads 18 with the installation apertures of the rails 102. For example, after application of the generally downward force, a perimeter of the installation apertures can abut the projections 16 so that the hanger system 10 can be at least partially supported by this interaction.

Additionally, in some embodiments, the movement of the hanger system 10 to engage with the installation apertures of the rail 102 can result in the hook 32 engaging further installation apertures. For example, in some embodiments, the extension 36 can move to engage the rail 102 to at least partially secure the hanger system 10 to the shelving units 100. Further, in some embodiments, the hook 32 can prevent movement of the hanger system 10 with respect to the shelving units 100. In some embodiments, the fastener 20 can be actuated to fix the length L of the hanger system 10. In some embodiments, a threaded stud 104 can be used to couple the support structure or support devices to the apertures 44. Further, in some embodiments, the threaded stud 104 can be coupled to one of the apertures 44, and can, at least partially, extend through the elongated aperture 46.

In some embodiments, the support structures or devices can include a sprinkler system, a security system, a registration system, a heating and ventilation system, or any other similar systems including ducted or piping-based systems. The security system can include video surveillance and motion detectors. The registration system can be used to determine whether a specific portion of the shelving units 100 is occupied. In some embodiments, the support structures or support devices can include channels and runways to hold electrical wiring, network cables, and any other suitable cables and wires or conduit.

To uninstall the hanger system 10, the support structures or devices can be removed from the hanger system and the fastener 20 can be actuated to allow for movement of the first member 12 relative to the second member 14. The hook 32 can be moved to disengage the installation apertures and the hanger system 10 can be moved so that the projections 16 and the heads 18 can disengage the installation apertures of the rail 102.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A hanger system comprising:
a first member, the first member comprising a first main body, a first plate, a first hook, and a first protrusion,
the first main body including at least one aperture,
the first hook capable of moving with respect to the first plate, and
the first hook and the first protrusion capable of at least partially engaging a building structure to at least partially support the hanger system;
a second member, the second member comprising a second main body, a second plate, a second hook, and a second protrusion,
the second hook capable of moving with respect to the second plate,
the second hook and the second protrusion capable of at least partially engaging the building structure to at least partially support the hanger system,
the first member and the second member capable of moving with respect to each other in order to adjust a first length of the hanger system, and
the second member capable of receiving a portion of the first member;
a fastener substantially positioned through a portion of the second member, the fastener capable of at least partially fixing a position of the first member with respect to the second member; and
an elongated aperture formed in the second main body, the elongated aperture capable of enabling a support structure to be coupled to the at least one aperture.

2. The hanger system of claim 1, wherein at least one of the first protrusion and the second protrusion comprise a head, the head capable of at least partially aiding in engaging the building structure to at least partially support the hanger system.

3. The hanger system of claim 1, wherein the first hook and the second hook each include a flat body and an extension.

4. The hanger system of claim 3, wherein the flat body of the first hook and the flat body of the second hook each comprise a leaf spring.

5. The hanger system of claim 1, wherein the first main body comprises three apertures.

6. The hanger system of claim 1, wherein the support structure includes a piping system of a sprinkler system.

7. The hanger system of claim 1, wherein the first length of the hanger system is one of about eight inches, about ten inches, and about twelve inches.

8. The hanger system of claim 1, wherein the building structure comprises at least one shelving unit.

9. The hanger system of claim 8, wherein the at least one shelving unit comprises a plurality of shelving units, and the plurality of shelving units each include installation apertures, wherein the hanger system is capable of engaging the installation apertures on the plurality of shelving units.

10. The hanger system of claim 1, wherein the second main body comprises a greater width than the first main body.

11. The hanger system of claim 1, wherein the first member and the second member include being formed from tube steel.

12. The hanger system of claim 1, wherein at least one of the first member and the second member comprises a plurality of protrusions.

13. A hanger system comprising:
a first member, the first member comprising a first main body and a first plate,
the first main body including at least one aperture and a first width,
the first plate including a first protrusion and a first hook,
the first hook and the first protrusion capable of at least partially engaging a building structure to at least partially support the hanger system;
a second member, the second member comprising a second main body and a second plate,
the second main body including a second width,
the second plate including a second protrusion and a second hook,
the second hook and the second protrusion capable of at least partially engaging the building structure to at least partially support the hanger system,
the first member and the second member capable of being moved with respect to each other in order to adjust a first length of the hanger system, and the second member capable of receiving a portion of the first member, and
the second width greater than the first width; and
an elongated aperture formed in the second member, the elongated aperture capable of enabling a support structure to be coupled to the at least one aperture.

14. The hanger system of claim 13, and further comprising a fastener substantially positioned through a portion of the second main body, the fastener capable of at least partially fixing a position of the first member with respect to the second member.

15. The hanger system of claim 13, wherein the first hook and the second hook are capable of moving with respect to the first plate and the second plate, respectively; and
the first hook and the second hook each comprise a flat body and an extension, each of the flat bodies comprising a leaf spring.

16. The hanger system of claim 13, wherein the building structure comprises a plurality of shelving units, and the plurality of shelving units each include installation apertures, wherein the hanger system is capable of engaging the installation apertures on the plurality of shelving units.

17. The hanger system of claim 13, wherein the support structure comprises a piping system of a sprinkler system.

18. The hanger system of claim 13, wherein the first length of the hanger system is one of about eight inches, about ten inches, and about twelve inches.

19. A method for securing a support structure to a building component, the method comprising:
providing a hanger system, the hanger system including a first member and a second member,
the first member comprising a first protrusion, at least one aperture, and a first hook,
the second member comprising a second protrusion, a second hook, and an elongated aperture formed in the second member, and
the second member including a fastener;
receiving a portion of the first member within the second member;
actuating the fastener to at least partially fix a position of the first member with respect to the second member;
engaging the first and second protrusions and the first and second hooks with the building component; and
coupling the support structure to the at least one aperture, the support structure extending at least partially though the elongated aperture.

20. The method of claim 19, and further comprising moving the first hook and the second hook to aid in engaging the building component.
